(19) United States
(12) Patent Application Publication
(10) Pub. No.: US 2022/0017135 A1
(43) Pub. Date: Jan. 20, 2022

(54) DISPOSABLE SHOPPING CART LINERS

(71) Applicant: Lizzette Padilla-Diamond, West Deptford, NJ (US)

(72) Inventor: Lizzette Padilla-Diamond, West Deptford, NJ (US)

(21) Appl. No.: 17/301,945

(22) Filed: Apr. 20, 2021

Related U.S. Application Data
(60) Provisional application No. 62/705,875, filed on Jul. 20, 2020.

(51) Int. Cl. B62B 5/00; A61J 9/06; B62B 5/06; B62B 5/08; A47F 13/00; A47D 15/00

(52) U.S. Cl. CPC B62B 5/0013; A61J 9/06; B62B 5/069; A41D 19/015; A47F 13/00; A47D 15/00; B62B 5/082

(57) ABSTRACT

A disposable cart liner includes a sheet of thin material having a perimeter formed by a first longitudinal edge, an opposing second longitudinal edge, a first lateral edge, and an opposing second lateral edge. A tension fastener is woven through apertures in the perimeter. The sheet fits at least around a handlebar and into a seat portion of a shopping cart. A cape is formed at the periphery. A shopping liner kit includes a container, a disposable cart liner, and one or more additional liners. The additional liners are chosen from a pair of disposable gloves with a tension fastener; a baby bottle liner with a tension fastener; and a toilet seat cover with a tension fastener.

### CROSS-REFERENCE TO RELATED APPLICATION

This application claims the benefit of priority of U.S. provisional application No. 62/705,875, filed Jul. 20, 2020, the contents of which are herein incorporated by reference.

### BACKGROUND OF THE INVENTION

The present invention relates to disposable sanitary liners and, more particularly, to disposable liners for shopping carts.

A disposable shopping cart liner is not currently commercially available. Existing shopping cart covers made to protect a baby from directly touching germs/viruses on a shopping cart are made from material that is not disposable and must be washed once contaminated by use on a shopping cart. Disposable liners for use with other devices are generally made of light material that rips easily and are not suitable for use on a shopping cart or highchair. Due to the present pandemic crisis, emergency health and safety measures are necessary to reduce the spread of coronavirus disease 2019 (COVID-19).

As can be seen, there is a need for a disposable shopping cart liner.

The present invention provides a disposable shopping cart liner. This liner comes in between the user's hand and the shopping cart surfaces to prevent direct contact with a dirty, virus-contaminated shopping cart.

The inventive disposable plastic liners may be used anywhere there is a health and safety restriction in effect and there is a need for additional pandemic precautions. These convenient liners are needed immediately in every store and everywhere else that has shopping carts. For example, the liners may be used at kiosk machines and/or shopping outlets. Once shopping is done, the liners may be easily pulled out of the shopping cart and thrown away, i.e., properly disposed, or reused if cleaned, for example with a disinfectant wipe. The inventive disposable gloves may be used with handheld store baskets.

The invention provides an extra emergency safety and health measure for consumers. The additional protection from viruses and germs allows them to shop with their mind at ease. The presence of visible protection may entice customers to shop more frequently. Consumers may have peace of mind when they leave and may consider coming back where these disposable plastic liners are located and virus free safety measures are implemented.

The liners may also be used as a small trash bag, for example after use in a shopping cart.

### SUMMARY OF THE INVENTION

In one aspect of the present invention, a disposable cart liner is provided, comprising a sheet of thin material having a perimeter formed by a first longitudinal edge, an opposing second longitudinal edge, a first lateral edge, and an opposing second lateral edge, wherein a tension fastener is woven through apertures in the perimeter.

In another aspect of the present invention, a disposable seat liner is provided, comprising a sheet of thin material having at least one tension fastener at a periphery of the sheet and a cape formed at the periphery, wherein the sheet is configured to fit at least around a handlebar and into a seat portion of a shopping cart.

In another aspect of the present invention, a shopping liner kit is provided, comprising a container; a disposable cart liner contained within the container, comprising a sheet of thin material having at least one tension fastener; and one or more additional liners contained within the container, wherein said one or more additional liners selected from the group consisting of: a pair of disposable gloves with a tension fastener; a baby bottle liner with a tension fastener; and a toilet seat cover with a tension fastener.

These and other features, aspects and advantages of the present invention will become better understood with reference to the following drawings, description, and claims.

### BRIEF DESCRIPTION OF THE DRAWINGS

FIG. 1 is a perspective view of a disposable shopping cart liner of an embodiment of the present invention;

FIG. 2 is an exploded perspective view thereof;

FIG. 3 is a perspective view of another embodiment of the present invention, showing a two-part configuration;

FIG. 4 is a perspective view thereof, shown in a costume configuration;

FIG. 5 is a perspective view thereof, shown in use on a highchair;

FIG. 6 is a top plan view thereof; and

FIG. 7 is a top plan view of a disposable shopping cart liner according to another embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As used herein, directional terms such as upper, lower, upward, downwardly, top, left, right and the like are used in relation to the illustrative embodiments as they are depicted in the figures, such that the upward direction (or upper) being toward the top of the corresponding figures and the downward direction being toward the bottom of the corresponding figures.

As used herein, a cart generally refers to a shopping cart having a cargo portion with a substantially rectangular base, a seat portion with a substantially rectangular base or bottom portion, and a handlebar. The seat portion may also have leg holes to accommodate a child's legs. The cargo portion and the seat portion generally have vertical walls extending from the base and having edges opposite the base.

As used herein, the term “unitary” means a component formed all in one piece (i.e., marked by unity).

Broadly, one embodiment of the present invention is a disposable cart liner with a tension fastener selected from the group consisting of a plastic drawstring tie, an adhesive tab, elastic, and combinations thereof. The inventive disposable cart liner may be fitted to a shopping cart.

Retail establishments with shopping carts may provide liners as a roll, packaged in bulk, individually packaged, or loose. When provided as a roll, contiguous sheets of plastic may be configured to form additional disposable cart liners. The liners may be handed to the customer, preplaced onto carts, or picked up from store dispensers. The customer may pull the plastic disposable straps under and around the appropriate part of the cart and under the handlebar and may fasten it accordingly. The liners may be used in either direction if no child is placed in the seat.

In some embodiments, the liner may be fitted to the “front part” of the cart having room to seat a child. The liner may cover the handlebar and surroundings (such as the back of the seat) with two holes or slits for the child's legs to safely dangle through. The holes or slits may be aligned with holes in the cart designed for passage of a child's legs. Alternatively, the liner may have no holes or slits, for example with carts that do not have leg apertures, to provide a protected place for your items. The liner may also have bound elastic instead of or in addition to a drawstring tie.

In some embodiments, the disposable liner may be configured to fit a baby highchair with two holes or slits for the child's legs to safely dangle through. The liner may have elastic bound to the perimeter to provide a more tailored fit.

In some embodiments, the liner may cover the front seat portion and the entire back cart cargo portion as a one-piece form-fitting liner. The liner may be positioned by pushing the liner down into seat cavity, tucking it down over the back of the seat into the four corners of the cargo bucket, and pressing the liner into the base of the cart.

In some embodiments, the liner may be configured to fit the entire cart cargo portion with the seat pulled in (i.e., closed) or absent.

In some embodiments, stitches may be added to better fit the form of the cart with the liner shape and to give extra support to keep liners down in place. The liner may be fitted to a child seat portion of a cart, with two rows of stitches on the right and left of the front and back (vertically) of the seat sides. A rectangular shape may be stitched into the liner for the bottom of the seat. Similarly, the cart liner may be fitted to the entire cart cargo portion with supporting lining stitches in four corners to guide the liner in place. The liner may be made to fit over the external sides of the cart for tension fastening.

The inventive liner may be held in place with a pull tie (also referred to herein as a drawstring tie). The liner may be provided with multiple holes to accept the drawstring tie, such as about 4 to about 18, e.g., about 9. Disposable shopping cart liners wrap gently in place with a simple tug on the plastic drawstring tie. The drawstring tie may either be woven through the perimeter of the disposable liner around the selected part of the shopping cart or the drawstring may be pre-attached to the liner using an adhesive tape tab. The tie is generally pulled snug during use to affix around the cart. In other embodiments, the liner may be secured with adhesive tabs or may be elastic bound.

The inventive liner and pull tie may be manufactured of a sheet of any suitable material. The material may be sturdy, yet thin enough to either dispose or wipe and reuse. The term “thin material” refers to a material that is less than about 2.0 mil thick. Preferably, the liner is manufactured from a plastic sheet and cut to the dimensions of a shopping cart. The drawstring tie is preferably manufactured from plastic as well. Alternatively, the liner may be manufactured from paper or another nonwoven material. Liners are preferably soft, yet hefty enough to support purchases, a child, or personal valuables while shopping without easily ripping. The inventive disposable shopping cart liners may fit the average shopping cart measurements, or they may be custom made to fit shopping carts. For example, the liners may be sized to fit a cart about 24 inches long by about 19 inches deep. The liner has a periphery; a unitary, substantially rectangular liner may have a periphery formed by a first longitudinal edge, an opposing second longitudinal edge, a first lateral edge, and an opposing second lateral edge, for example.

In some embodiments, the inventive shopping cart liners may have a watermark for marketing or instruction purposes. For example, in some embodiments, the term “handlebar” may be printed or water-marked on the liner as an indicator for proper alignment.

In some embodiments, the liner may include a cape at a periphery of the liner positioned opposite leg holes or slits. A hood may also be provided, colocated with the cape at the periphery of the liner.

In some embodiments, the cart liner may be accompanied by additional liners and/or accessories in a container to form a kit. The additional liners may include articles selected from the group consisting of: a pair of disposable gloves with a tension fastener; a baby bottle liner with a tension fastener; a toilet seat cover with a tension fastener; and a combination thereof. For example, the kit may include one size fits all disposable gloves with an adhesive tab or elastic for tension around the user's wrist. Disposable gloves may be used for hand baskets. Also, an elastic-bound baby bottle liner may help protect baby from germs on bottles. Accessories in the kit may include but are not limited to a crown and an eyemask.

In some embodiments, the invention also provides toilet covers for placement on top of a toilet seat. Generally, the inventive toilet covers are not flushable. The toilet covers may have adhesive tabs on the perimeter to securely hold the covers during use. The toilet covers may have the shape of a toilet seat stitched into the material to help the cover better fit the seat.

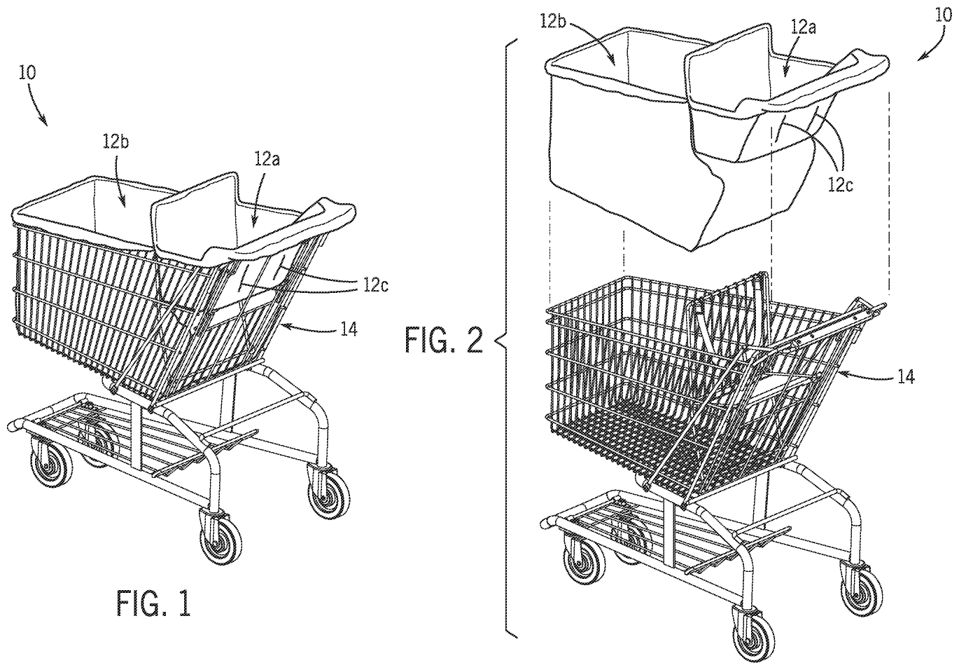

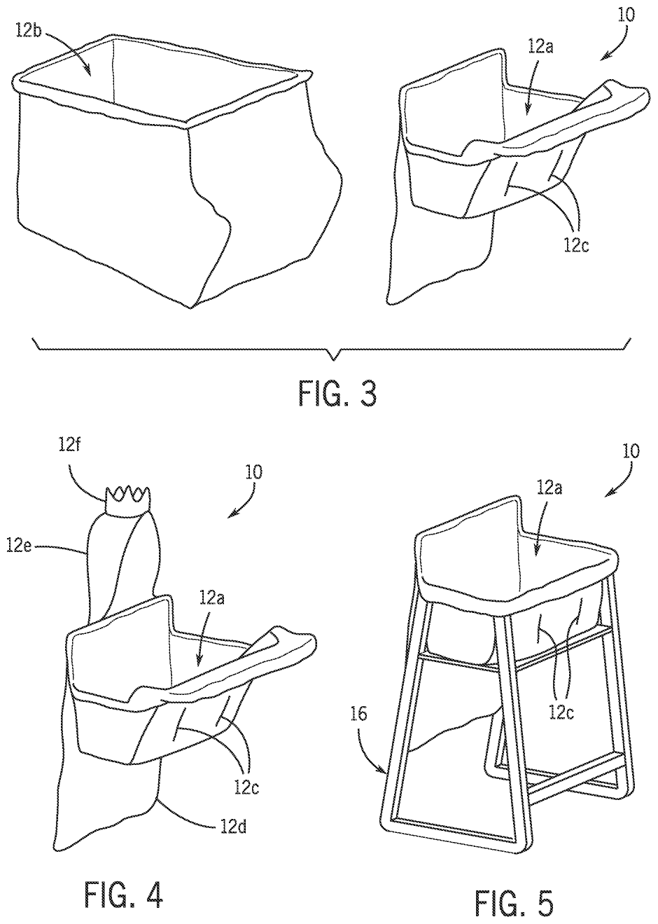

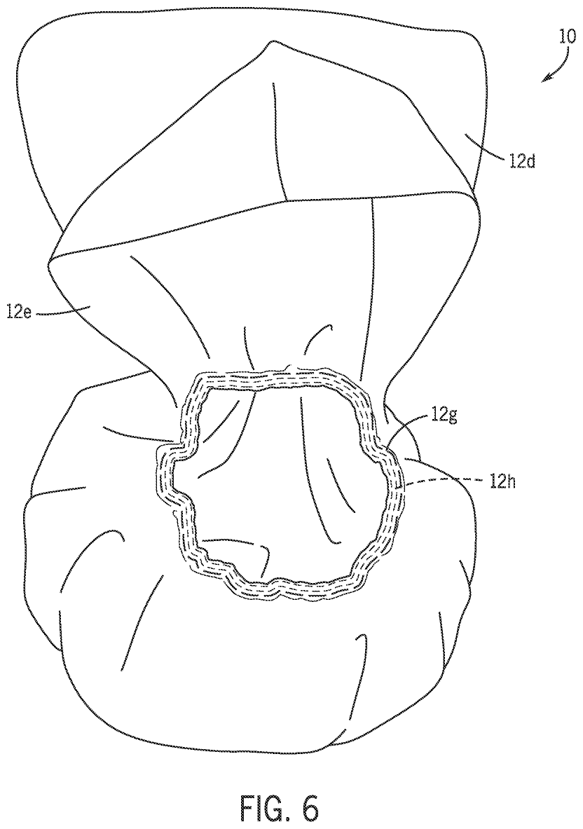

Referring to FIGS. 1 through 6, FIG. 1 shows an overall disposable shopping cart liner 10 according to an embodiment of the present invention positioned for use on a shopping cart 14 and covering all upper portions of the shopping cart 14. The shopping cart liner 10 comprises a seat liner 12a with slits 12c for a child's legs, and a basin liner 12b. The shopping car liner 10 may be a unitary device or, as shown in FIG. 3, the seat liner 12a may be an independent portion from the basin liner 12b. In some embodiments, the seat liner 12a may further comprise a cape 12d, a hood 12e, a crown 12f. In some embodiments, the seat liner 12a may be used on a highchair 16, as shown in FIG. 5. As shown in FIG. 6, elastic 12h may be provided along the edges of the shopper cart liner 10 and held in place with stitching 12g so that the liner 10 better fits the form of the cart 14 or highchair 16.

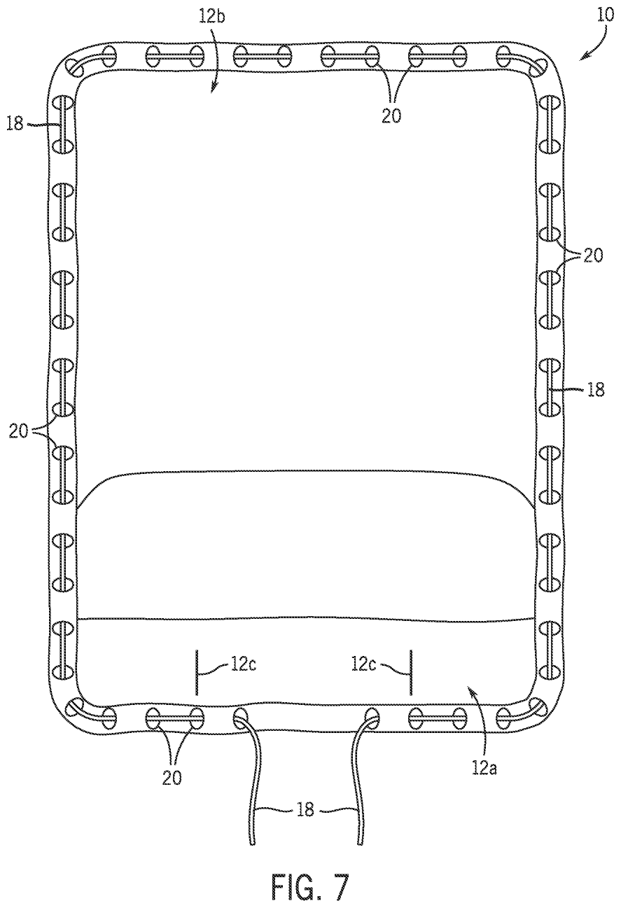

As shown in FIG. 7, the disposable shopping cart liner 10 may have a drawstring 18 woven through holes 20 in the liner perimeter. The drawstring may be pulled to tighten the liner on the cart, keeping the basin liner portion 12b and the seat liner portion 12a in place.

It should be understood, of course, that the foregoing relates to exemplary embodiments of the invention and that modifications may be made without departing from the spirit and scope of the invention as set forth in the following claims.

What is claimed is:

1. A disposable cart liner, comprising a sheet of thin material having a perimeter formed by a first longitudinal edge, an opposing second longitudinal edge, a first lateral edge, and an opposing second lateral edge, wherein a tension fastener is woven through apertures in the perimeter.

2. The disposable cart liner of claim 1, wherein the tension fastener is selected from the group consisting of a pull tie, elastic, and a combination thereof.

3. The disposable cart liner of claim 1, wherein the sheet of thin material is attached to at least one contiguous sheet configured to form an additional disposable cart liner.

4. The disposable cart liner of claim 1, wherein the sheet is unitary, substantially rectangular, and configured to fit around a cart handlebar into a cart seat portion and a cart cargo portion, and over edges of the cart seat portion and the cart cargo portion.

5. The disposable cart liner of claim 1, wherein the sheet is configured to encompass a cart cargo portion and a cart handlebar when a cart seat is closed or absent.

6. A disposable seat liner, comprising a sheet of thin material having at least one tension fastener at a periphery of the sheet and a cape formed at the periphery, wherein the sheet is configured to fit at least around a handlebar and into a seat portion of a shopping cart.

7. The disposable seat liner of claim 6, further comprising a hood formed at the periphery, colocated with the cape.

8. The disposable seat liner of claim 6, further comprising stitching configured to align with edges of a substantially rectangular seat bottom.

9. The disposable seat liner of claim 6, wherein the sheet has a watermark thereon.

10. The disposable seat liner of claim 6, with a first slit aligned with a first leg hole in a cart seat and a second slit aligned with a second leg hole in a cart seat.

11. A shopping liner kit comprising:
a) a container;
b) a disposable cart liner contained within the container, comprising a sheet of thin material having at least one tension fastener; and
c) one or more additional liners contained within the container, wherein said one or more additional liners are selected from the group consisting of: a pair of disposable gloves with a tension fastener; a baby bottle liner with a tension fastener; and a toilet seat cover with a tension fastener.

12. The shopping liner kit of claim 11, wherein the tension fastener of the disposable cart liner and the tension fastener of the one or more additional liners are each selected from the group consisting of: a pull tie, elastic bound about a perimeter of the sheet; an adhesive tab; and combinations thereof.

13. The shopping liner kit of claim 11, wherein the disposable cart liner further comprises a cape formed at a periphery of the sheet.

14. The shopping liner kit of claim 11, wherein the disposable cart liner further comprises stitching configured to align with edges of a substantially rectangular cart cargo base and/or a substantially rectangular cart seat base.

15. The shopping liner kit of claim 11, further comprising an accessory selected from the group consisting of: a crown, an eyemask, gloves, and a combination thereof.
